(19) United States
(12) Patent Application Publication
(10) Pub. No.: US 2022/0383843 A1
(43) Pub. Date: Dec. 1, 2022

(54) ARRANGEMENT GENERATION METHOD, ARRANGEMENT GENERATION DEVICE, AND GENERATION PROGRAM

(71) Applicant: Yamaha Corporation, Hamamatsu (JP)

(72) Inventor: Masahiro SUZUKI, Hamamatsu (JP)

(21) Appl. No.: 17/886,452

(22) Filed: Aug. 11, 2022

Related U.S. Application Data
(63) Continuation of application No. PCT/JP2021/004815, filed on Feb. 9, 2021.

(30) Foreign Application Priority Data
Feb. 17, 2020 (JP) 2020-024482

(51) Int. Cl. G10H 1/00; G10H 1/40

(52) U.S. Cl. CPC G10H 1/0025; G10H 1/40

(57) ABSTRACT

An arrangement generation method executed by a computer includes acquiring target musical piece data that include performance information that indicates a melody and a chord of at least a part of a musical piece and include meta information that indicates characteristics of at least the part of the musical piece, generating, from the acquired target musical piece data, by using a generative model trained by machine learning, arrangement data obtained by arranging the performance information in accordance with the meta information, and outputting the generated arrangement data.

### CROSS-REFERENCE TO RELATED APPLICATIONS

This application is a continuation application of International Application No. PCT/JP2021/004815, filed on Feb. 9, 2021, which claims priority to Japanese Patent Application No. 2020-024482 filed in Japan on Feb. 17, 2020. The entire disclosures of International Application No. PCT/JP2021/004815 and Japanese Patent Application No. 2020-024482 are hereby incorporated herein by reference.

### BACKGROUND

### Technological Field

This disclosure relates to an arrangement generation method, an arrangement generation device, and a generation program for generating an arrangement of a musical piece using a trained generative model generated by machine learning.

### Background Information

The generation of a musical is a stepwise process. In general, a musical score is generated by following such steps as generating the basic composition of the musical piece (melody (tune), rhythm, harmony (chords)), generating an arrangement based on the basic composition, laying out elements such as performance symbols and notes that correspond to the generated musical piece (arrangement) in order to generate musical score data, and outputting the musical score data to a paper medium, etc. Conventionally, the foregoing steps are the product of human labor (e.g., manual operations of computer software).

However, performing all the steps for generating a musical score manually raises the cost of generating the musical score. Thus, in recent years, the development of a technology for automating at least some of the steps for generating a musical score has been advanced. For example, Japanese Laid-Open Patent Application No. 2017-58594 proposes a technology for automatically generating accompaniment (backing) data by arrangement. By this technology, since some of the steps for generating an arrangement can be automated, the cost of generating the arrangement can be reduced.

### SUMMARY

The present inventors have found that the conventional method of generating arrangements as proposed in Japanese Laid-Open Patent Application No. 2017-58594, etc., has the following problems. That is, in the conventional technology, accompaniment data are generated from performance information in accordance with a prescribed algorithm. However, because automatic arrangements are based on a wide variety of musical pieces, a prescribed algorithm does not necessarily match the performance information (musical piece). If the original performance information does not match the prescribed arrangement, the arrangement may deviate from the original piece, and appropriate data may not be generated. Moreover, with the conventional method, only uniform arrangement data that follow a prescribed algorithm can be generated, so that automatically generating various arrangement data is difficult. Consequently, the suitable generation of various data by the conventional method is difficult.

This disclosure was conceived in light of the foregoing circumstances, and an object thereof is to reduce the cost of generating arrangement data, as well as to provide a technology for the suitable generation of various arrangement data.

In order to solve the above-mentioned problem, this disclosure employs the following configuration. That is, the arrangement generation method according to one aspect of this disclosure, which is executed by a computer, comprises acquiring target musical piece data that include performance information that indicates a melody and a chord of at least a part of a musical piece and include meta information that indicates characteristics of at least the part of the musical piece, generating, from the acquired target musical piece data, by using a generative model trained by machine learning, arrangement data obtained by arranging the performance information in accordance with the meta information, and outputting the generated arrangement data.

### BRIEF DESCRIPTION OF THE DRAWINGS

FIG. 1 schematically illustrates one example of a scenario in which this disclosure is applied.

FIG. 2 schematically illustrates one example of the hardware configuration of the arrangement generation device according to an embodiment.

FIG. 3 schematically illustrates one example of the software configuration of the arrangement generation device according to the embodiment.

FIG. 4 is a musical score showing one example of melody and chords of performance information according to the embodiment.

FIG. 5 is a musical score showing one example of an arrangement generated based on the melody and the chords shown in FIG. 4.

FIG. 6 schematically illustrates one example of the configuration of a generative model according to the embodiment.

FIG. 7 is a diagram for explaining one example of tokens that are input to the generative model according to the embodiment.

FIG. 8 is a diagram for explaining one example of tokens that are output from the generative model according to the embodiment.

FIG. 9 is a flowchart showing one example of the process procedure of machine learning of the generative model carried out by the arrangement generation device according to the embodiment.

FIG. 10 is a flowchart showing one example of the procedure of an arrangement data generation process (inference process by the generative model) carried out by the arrangement generation device according to the embodiment.

FIG. 11 is a diagram for explaining one example of tokens that are input to the generative model according to a modified example.

FIG. 12 is a diagram for explaining one example of tokens that are output from the generative model according to the modified example.

FIG. 13 schematically illustrates one example of a scenario in which this disclosure is applied.

### DETAILED DESCRIPTION OF THE EMBODIMENTS

An embodiment according to one aspect of this disclosure (hereinafter also referred to as “present embodiment”) will be described below with reference to the drawings. However, the present embodiment described below is merely an example of this disclosure in all respects. It goes without saying that various improvements and modifications can be made without departing from the scope of this disclosure. That is, when this disclosure is put into practice, specific configurations that correspond to the embodiment can be appropriately employed. The data that appear in the present embodiment are described using natural language, but, more specifically, the data can be specified in a pseudo language, commands, parameters, machine language, etc., that can be recognized by a computer.

1. Application Example

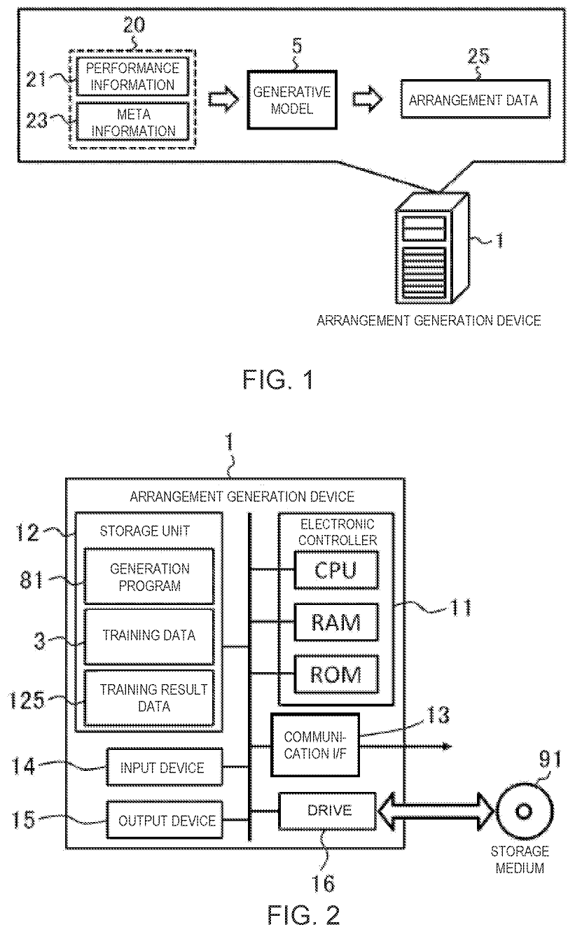

FIG. 1 schematically depicts one example of a scenario in which this disclosure is applied. An arrangement generation device 1 according to the present embodiment is a computer configured to use a trained generative model 5 to generate arrangement data 25 of a musical piece.

First, the arrangement generation device 1 according to the present embodiment acquires target musical piece data 20 that include performance information 21 that indicates at least a part of the melody (tune) and harmony (chords) of a musical piece and meta information 23 that indicates characteristics of at least a part of the musical piece. The arrangement generation device 1 then, by using the trained generative model 5 trained by machine learning, generates the arrangement data 25 from the acquired target musical piece data 20. The arrangement data 25 can be obtained by arranging the performance information 21 in accordance with the meta information 23. That is, the meta information 23 corresponds to an arrangement generation condition. The arrangement generation device 1 outputs the generated arrangement data 25.

As described above, in the present embodiment, the trained generative model 5 generated by machine learning is used to generate the arrangement data 25 from the target musical piece data 20 that include the original performance information 21. By using sufficient training data to suitably execute machine learning, the trained generative model 5 can acquire the ability to suitably generate arrangement data from a variety of original performance information. Thus, by using a trained generative model that has acquired such an ability, the arrangement data 25 can be suitably generated. Moreover, by the meta information 23, it is possible to control the generation conditions of the arrangement data 25. Further, by using the trained generative model 5, it is possible to automate at least some of the steps for generating the arrangement data 25. Thus, by the present embodiment, it is possible to reduce the cost of generating the arrangement data 25, as well as to appropriately generate various arrangement data 25.

2. Configuration Examples

### 2.1 Hardware Configuration

FIG. 2 schematically illustrates one example of the hardware configuration of the arrangement generation device 1 according to the present embodiment. As shown in FIG. 2, the arrangement generation device 1 according to the present embodiment is a computer to which an electronic controller (control unit) 11, a storage device 12, a communication device 13, an input device 14, an output device 15, and a drive 16 are electrically connected. In FIG. 2, the communication interface is described as “communication I/F.”

The electronic controller 11 includes at least one processor such as a CPU (Central Processing Unit), a RAM (Random Access Memory), a ROM (Read Only Memory), etc., which are examples of hardware processors (processor resources), and is configured to execute information processing based on a program and various data. The term “electronic controller” as used herein refers to hardware that executes software programs.

The storage unit 12 is one example of a memory (computer memory). The storage unit 12 can be any computer storage device or any computer readable medium with the sole exception of a transitory, propagating signal, and can include nonvolatile memory and volatile memory. Any known storage medium, such as a magnetic storage medium or a semiconductor storage medium, or a combination of a plurality of types of storage media can be freely employed as the storage unit 12. For example, the storage unit 12 is formed by a hard disk drive, a solid-state drive, etc. In the present embodiment, the storage unit 12 stores various information, such as a generation program 81, training data 3, learning result data 125, etc.

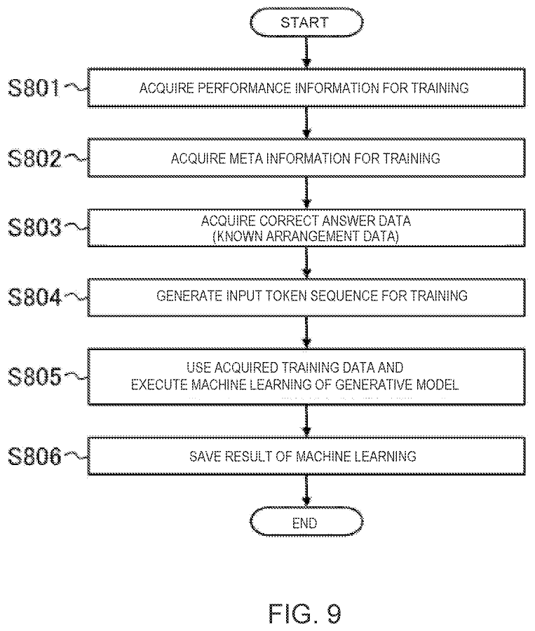

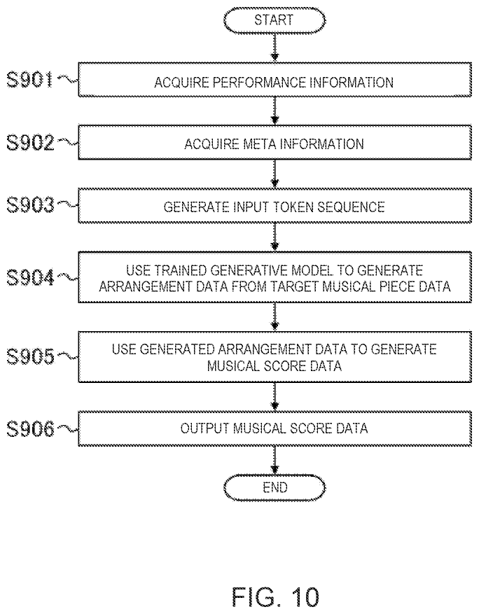

The generation program 81 causes the arrangement generation device 1 to execute information processing (FIGS. 9 and 10), described further below, related to the machine learning of the generative model 5 and the generation of the arrangement data 25 using the trained generative model 5. The generation program 81 includes a series of instructions for the information processing. The training data 3 is used for the machine learning of the generative model 5. The training result data 125 indicates information related to the trained generative model 5. In the present embodiment, the training result data 125 is generated as a result of executing the process of the machine learning of the generative model 5. The details will be described further below.

The communication interface 13 is an interface for carrying out wired or wireless communication via a network, such as a wired LAN (Local Area Network) module, a wireless LAN module, etc. The arrangement generation device 1 can use the communication interface 13 to execute data communication via a network with other information processing devices.

The input device (user operable input(s)) 14 is a device such as a mouse, a keyboard, etc., for inputting data. Further, the output device 15 is a device such as a display such as a liquid-crystal display panel or an organic EL (Electroluminescent) display panel, a speaker, etc., for outputting data. In one example, the input device 14 and the output device 15 can be configured separately. In another example, the input device 14 and the output device 15 can be integrally configured as a touch panel display, etc., for example. An operator, such as a user, can use the input device 14 and the output device 15 to operate the arrangement generation device 1.

The drive 16 is a CD drive, a DVD drive, etc., used to read various information such as programs stored on a storage medium 91. The storage medium 91 accumulates information, such as programs, by electronic, magnetic, optical, mechanical, or chemical actions, such that the computer and other devices and machines can read the various stored information such as programs. The generation program 81 and/or the training data 3 can be stored on the storage medium 91. The arrangement generation device 1 can acquire the generation program 81 and/or the training data 3 from the storage medium 91. A disc-type storage medium, such as a CD or a DVD, is shown in FIG. 2 as one example of the storage medium 91. However, the storage medium 91 is not limited to disc-type storage media but can be of a different type of medium. An example of a different type of storage medium besides the disc-type medium is semiconductor memory, such as flash memory. The type of drive 16 can be arbitrarily selected in accordance with the type of storage medium 91.

With respect to the specific hardware configuration of the arrangement generation device 1, constituent elements can be omitted, replaced, or supplemented as deemed appropriate in accordance with the embodiment. For example, the electronic controller 11 can include a plurality of hardware processors. The type of hardware processor is not limited to CPUs. The hardware processor can be formed by, for example, a microprocessor, an FPGA (field-programmable gate array), a GPU (Graphics Processing Unit), etc. The storage unit 12 can be formed by the RAM and the ROM included in the electronic controller 11. At least one or more of the communication interface 13, the input device 14, the output device 15, or the drive 16, can be omitted. The arrangement generation device 1 can include an external interface for connection to an external device. The external interface can be a USB (Universal Serial Bus) port, a dedicated port, etc. The arrangement generation device 1 can be formed by a plurality of computers. Here, the hardware configuration of each computer can or cannot be the same. Moreover, the arrangement generation device 1 can be, in addition to an information processing device designed exclusively for the service to be provided, a general-purpose PC (Personal Computer), a mobile terminal (e.g., a smartphone or tablet PC), etc.

### 2.2 Software Configuration

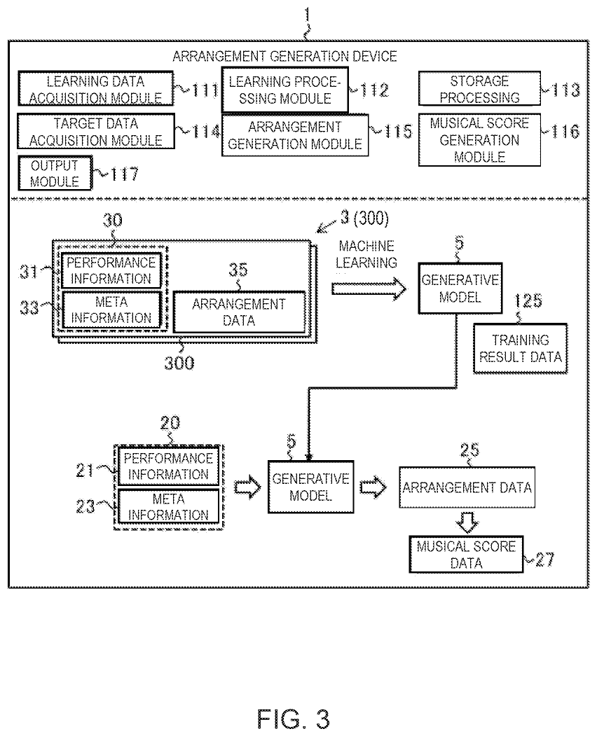

FIG. 3 schematically illustrates one example of the software configuration of the arrangement generation device 1 according to the present embodiment. The electronic controller 11 of the arrangement generation device 1 interprets and executes, by the CPU, instructions included in the generation program 81 stored in the storage device 12, thereby controlling each constituent element. The arrangement generation device 1 according to the present embodiment is thus configured to comprise a training data acquisition module 111, a learning processing module 112, a storage processing module 113, a target data acquisition module 114, an arrangement generation module 115, a musical score generation module 116, and an output module 117 as software modules. That is, in the present embodiment, each software module of the arrangement generation device 1 is realized by the electronic controller 11 (CPU).

The training data acquisition module 111 is configured to acquire the training data 3. The training data 3 includes a plurality of training datasets 300. Each of the training datasets 300 is made up of a combination of training music data 30 and known arrangement data 35. The training music data 30 are used as training data in the machine learning of the generative model 5. The training music data 30 includes performance information 31 that indicates at least a part of the melody and chords of a musical piece, and meta information 33 that indicates characteristics of at least a part of the musical piece. The meta information 33 indicates conditions for generating the corresponding known arrangement data 35 from the performance information 31.

The learning processing module 112 is configured to use the acquired plurality of training datasets 300 and execute the machine learning of the generative model 5. The storage processing module 113 is configured to generate information related to the trained generative model 5 generated by machine learning as the training result data 125 and to store the generated training result data 125 in a prescribed storage area. The training result data 125 can be appropriately configured to include information for reproducing the trained generative model 5.

The target data acquisition module 114 is configured to acquire the target musical piece data 20 that include the performance information 21 that indicates the melody and chord of at least a part of a musical piece and the meta information 23 that indicates characteristics of at least the part of the musical piece. The target musical piece data 20 (that is, the music data that is the source of the arrangement) can be arranged by being input to the trained generative model 5. The arrangement generation module 115 holds the training result data 125 and is thus provided with the trained generative model 5. The arrangement generation module 115 generates the arrangement data 25 from the acquired target musical piece data 20 by using the trained generative model 5 trained by machine learning. The arrangement data 25 is obtained by arranging the performance information 21 in accordance with the meta information 23. The musical score generation module 116 is configured to generate musical score data 27 by using the generated arrangement data 25. The output module 117 is configured to output the generated arrangement data 25. In the present embodiment, the outputting of the arrangement data 25 can be configured by outputting of the generated musical score data 27.

Various Data

The performance information (21, 31) can be appropriately configured to indicate the melody and chords of at least a part of the musical piece. Here, at least the part of the musical piece can be defined as a prescribed length, such as four measures. In one example, the performance information (21, 31) can be directly provided. In another example, the performance information (21, 31) can be obtained from data in other formats, such as a musical score. As a specific example, the performance information (21, 31) can be acquired from various types of original data that indicate the performance of a musical piece that includes the melody and the chords. The original data can be, for example, MIDI data, audio waveform data, etc. In one example, the original data can be read from a memory resource of the device itself, such as the storage device 12 or the storage medium 91. In another example, the original data can be obtained from an external device, such as another smartphone, a musical piece supply server, or NAS (Network Attached Storage). The original data can include data other than the melody and the chords. The chords in the performance information (21, 31) can be specified by executing a chord estimation process with respect to the original data. A known method can be used for the chord estimation process.

The meta information (23, 33) can be appropriately configured to indicate the arrangement generation conditions. In the present embodiment, the meta information (23, 33) can be configured to include at least one or more of difficulty level information, style information, composition information, or tempo information. The difficulty level information is configured to indicate the playing difficulty as the arrangement condition. In one example, the difficulty level information can include a value that indicates the degree of difficulty (such as any one of “beginner,” “beginner-intermediate,” “intermediate,” “intermediate-advanced,” and “advanced”). The style information is configured to indicate the musical style of the arrangement as the arrangement condition. In one example, the style information can be configured to include arranger information (e.g., an arranger ID) for identifying the arranger (arranger) and/or artist information (e.g., an artist ID) for identifying the artist.

The composition information is configured to indicate the musical instrument composition in the musical piece as the arrangement condition. In one example, the composition information can include a value that indicates the category of the musical instrument used in the arrangement. The category of the musical instrument can be provided in accordance with the GM (General MIDI) standard, for example. The tempo information is configured to indicate the tempo of the musical piece. In one example, the tempo information can include a value that indicates the tempo range to which the musical piece belongs, from among a plurality of tempo ranges (e.g., BPM=less than 60, 60 or more and less than 84, 84 or more and less than 108, 108 or more and less than 144, 144 or more and less than 192, and 192 and more).

In the context of machine learning, the meta information 33 can be pre-associated with a corresponding known arrangement data. 35, in which case the meta information 33 can be acquired from the known arrangement data 35. The meta information 33 can be acquired by analyzing the corresponding known arrangement data 35. The meta information 33 can be acquired by input via the input device 14 from an operator who specified the performance information 31 (e.g., the person who input the original data). On the other hand, in the context of an inference process (arrangement generation), the meta information 23 can be appropriately determined so as to specify the condition of the arrangement to be generated. In one example, the meta information 23 can be automatically selected by the arrangement generation device 1 or another computer by a method such as a determination in accordance with a prescribed rule, for example. In another example, the meta information 23 can be acquired by an input via the input device 14 from a user who wishes to generate the arrangement data.

The arrangement data (25, 35) are configured to include accompaniment sounds (arrangement sounds) that correspond to the melody and the chords of at least a part of the musical piece. The arrangement data (25, 35) can be acquired in the form of a standard MIDI file (SW), for example. In the context of machine learning, the known arrangement data 35 can be suitably acquired in accordance with the performance information 31 and the meta information 33 so as to be capable of being used as correct answer data. The known arrangement data 35 can be automatically generated from the performance information 31 in accordance with a prescribed algorithm or can be at least partially generated manually. The known arrangement data 35 can be generated based on known musical score data.

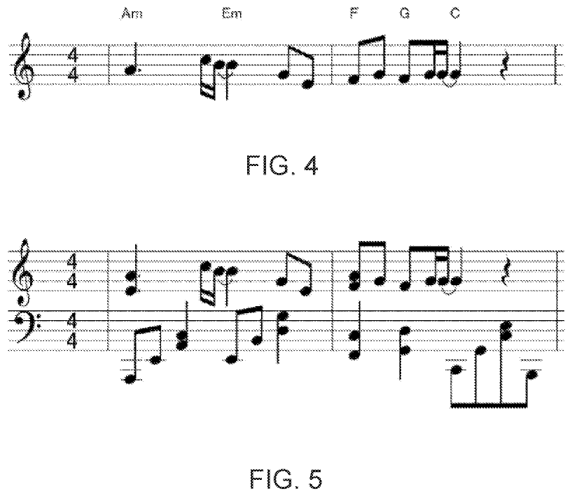

FIG. 4 is a musical score showing one example of melody and chords of the performance information (21, 31) according to the present embodiment. As shown in FIG. 4, the performance information (21, 31) can be configured to include a melody (monophony) composed of a sequence of single notes (including rests), and chords (chord information such as Am, F, etc.) in temporal progression.

FIG. 5 is a musical score showing one example of an arrangement generated based on the melody and the chords shown in FIG. 4. As shown in FIG. 5, the arrangement data (25, 35) can include a plurality of performance parts (in one example, the right-hand and left-hand parts for piano). In addition to melody sounds constituting the melody included in the performance information (21, 31), the arrangement data (25, 35) can be configured to include accompaniment sounds (arrangement sounds) that correspond to the melody and the chords.

In the example shown in FIGS. 4 and 5, at the beginning of the first measure, the melody included in the performance information (21, 31) has an A note (dotted quarter note), and the chord is A minor (the VI chord in C major, which is the key in the present example). Correspondingly, in addition to the melody sounds included in the right-hand part, the arrangement data (25, 35) include an A note (eighth note of the front beat) and an F note (dotted quarter note on the front beat and an eighth note on the back beat), which are constituent notes of A minor, as the accompaniment sounds in accordance with the law of harmony.

As illustrated in the figure, the accompaniment sounds included in the arrangement data (25, 35) are not limited to sounds obtained by simply extending the sounds constituting the chord. The arrangement data (25, 35) can include, in addition to chords, sounds (e.g., contrapuntally structured sounds) that correspond to the pitch and rhythm of the melody.

Configuration Example of the Generative Model

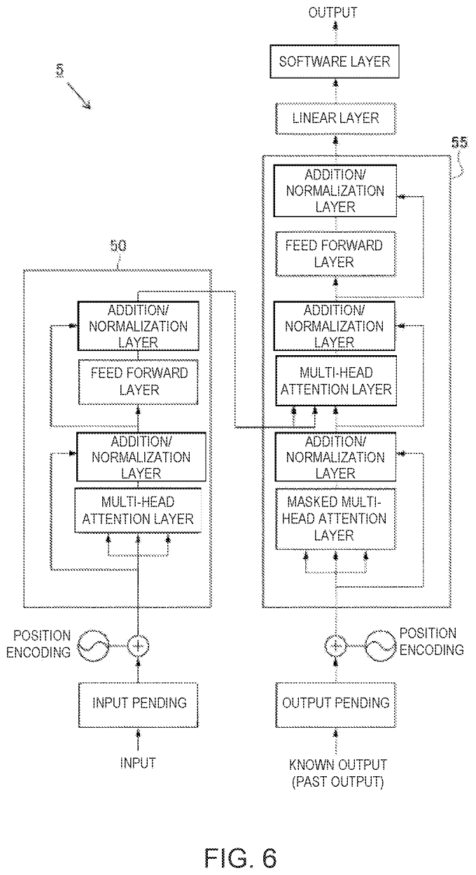

FIG. 6 schematically illustrates one example of the configuration of the generative model 5 according to the present embodiment. The generative model 5 includes a machine learning model that has machine learning-adjusted parameters. The type of machine learning model is not particularly limited and can be appropriately selected in accordance with the embodiment. As shown in FIG. 6, in one example, the generative model 5 can have a configuration based on a Transformer as proposed in the reference document “Ashish Vaswani, Noam Shazeer, Niki Parmar, Jakob Uszkoreit, LLion Jones, Aidan N Gomez, Lukasz Kaiser, and Illia Polosukhin, Attention is all you need. In Advances in Neural Information Processing Systems, 2017.” A Transformer is a machine learning model that processes series data (natural language, etc.) and has an attention-based configuration.

In the example of FIG. 6, the generative model 5 has an encoder 50 and a decoder 55. The encoder 50 has a structure formed by a stacked plurality of blocks, each having a multi-head attention layer that seeks self-attention, and a feed-forward layer. The decoder 55, on the other hand, has a structure formed by a stacked a plurality of blocks, each having a masked multi-head attention layer that seeks self-attention, a multi-head attention layer that seeks source/target attention, and a feed-forward layer. As shown in FIG. 6, an addition and normalization layer can be provided to each of the layers of the encoder 50 and the decoder 55. Each layer can include one or more nodes, and a threshold value can be set for each node. The threshold value can be expressed by an activation function. Further, a weight (connection load) can be set for the connections between nodes of adjacent layers. The threshold value and the weights of the connections between nodes are examples of the parameters of the generative model 5.

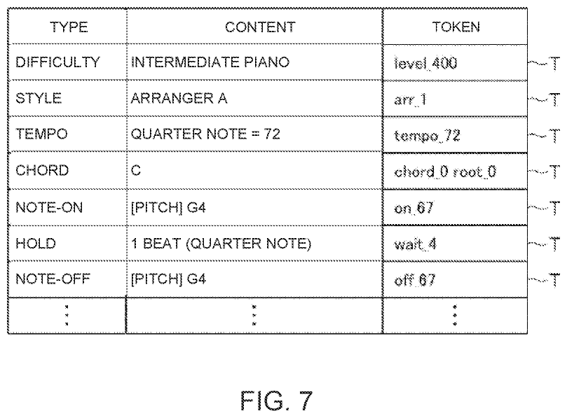

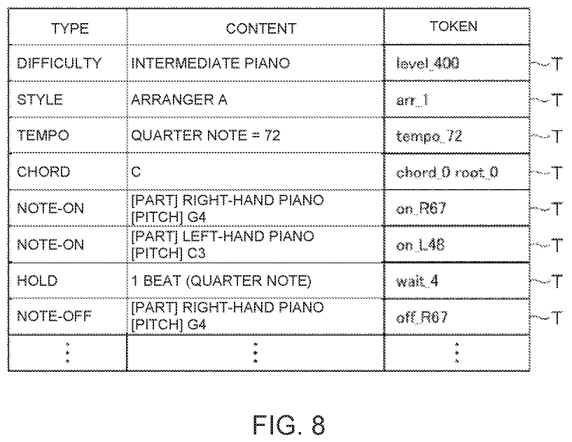

Further, one example of the input format and the output format of the generative model 5 will be described using FIGS. 7 and 8. FIG. 7 is a diagram for explaining one example of an input format (token) of music data that are input to the generative model 5 according to the present embodiment. FIG. 8 is a diagram for explaining one example of an output format (token) of the arrangement data that are output from the generative model 5 according to the present embodiment. As shown in FIG. 7, in the present embodiment, in the context of machine learning and inference processing, the music data (20, 30) are converted into an input token sequence that includes a plurality of tokens T. The input token sequence can be appropriately generated so as to correspond to the music data (20, 30).

At the stage of machine learning, the learning processing module 112 is configured to input to the generative model 5 tokens included in the input token sequence that corresponds to the training music data 30 and to carry out the computation of the generative model 5 to generate an output token sequence that corresponds to the arrangement data (inference result). In the inference stage, on the other hand, the arrangement generation module 115 is configured to input to the trained generative model 5 tokens included in the input token sequence that correspond to the target musical piece data 20 of the arrangement and to carry out the computational processing of the trained generative model 5 to generate the output token sequence that corresponds to the arrangement data 25.

As illustrated in FIG. 7, each token T included in the input token sequence is an information element that indicates the performance information (21, 31) or the meta information (23, 33). A difficulty token (e.g., level_400) indicates difficulty level information (e.g., intermediate piano) included in the meta information (23, 33). A style token (e.g., arr_1) indicates style information (e.g., arranger A) included in the meta information (23, 33). A tempo token (e.g., tempo_72) indicates tempo information (e.g., a tempo range near quarter note=72) included in the meta information (23, 33).

A chord token (e.g., chord_0 root_0) indicates a chord (e.g., C major whose root note is C) included in the performance information (21, 31). A note-on token (e.g., on_67), a hold token (e.g., wait_4), and a note-off token (e.g., off_67) include notes (e.g., a quarter note with a pitch G4) constituting the melody included in the performance information (21, 31). A note-on token indicates the pitch of the sound to be newly sounded, a note-off token indicates a pitch of the sound to be stopped, and a hold token indicates the length of time that the sounded (or silent) state should be maintained. Therefore, a prescribed sound is sounded by a note-on token, the state in which the above-described sound is sounded is maintained by a hold token, and the above-described sound is stopped by a note-off token.

In the present embodiment, an input token sequence is configured such that after a token(s) T corresponding to the meta information (23, 33) is(are) arranged, the tokens T that correspond to the performance information (21, 31) are arranged in chronological order. In the example of FIG. 7, in the input token sequence, tokens T of various information included in the meta information (23, 33) are arranged in the order of difficulty token, style token, and tempo token. However, when the meta information (23, 33) includes a plurality of types of information, the arrangement order of the tokens T that correspond to the various information of the meta information (23, 33) in the input token sequence is not limited to such an example, and can be appropriately determined in accordance with the embodiment.

As shown in FIG. 6, the generative model 5 according to the present embodiment is configured to receive the input of the tokens included in the input token sequence in order from the beginning. The tokens input to the generative model 5 are respectively converted into vectors having a prescribed number of dimensions by an input embedding process and are provided with a value specifying the position within the musical piece (within the phrase) by a position encoding process, and are thereafter input to the encoder 50. With respect to this input, the encoder 50 continually carries out processing by the multi-head attention layer and the feed-forward layer for the number of blocks to acquire a feature expression and supplies the acquired feature expression to the decoder 55 (multi-head attention layer) of the next stage.

In addition to the input from the encoder 50, known (past) outputs from the decoder 55 (masked multi-head attention layer) are supplied to the decoder 55. That is, the generative model 5 according to the present embodiment is configured to have a recursive structure. With respect to this input, the decoder 55 repeatedly executes processing by the masked multi-head attention layer, the multi-head attention layer, and the feed-forward layer for the number of blocks to acquire and output a feature expression. The output from the decoder 55 is converted to a linear layer and a softmax layer and is output as the token T to which information that corresponds to the arrangement is added.

As illustrated in FIG. 8, each token T output from the generative model 5 is an information element that indicates the performance information or the meta information, and constitutes the arrangement data. The plurality of tokens T sequentially obtained from the generative model 5 make up the output token sequence that corresponds to the arrangement data. Since the tokens T that correspond to the meta information are the same as the input token sequence (FIG. 7), their explanation will be omitted.

The tokens T (note-on token, note-off token) that indicate the performance information included in the arrangement data can correspond to the sounds of a plurality of performance parts (piano right-hand and left-hand parts). That is, as shown in FIG. 5 above, the plurality of tokens T (output token sequence) output from the generative model 5 can be configured to indicate accompaniment sounds (arrangement sounds) that correspond to the melody and the chords, in addition to the melody sounds constituting the melody indicated by the tokens T that correspond to the input performance information (21, 31).

In the same manner as the input token sequence, the output token sequence is configured such that after the tokens that correspond to the meta information are arranged, the tokens T that correspond to the performance information are arranged in chronological order. The arrangement order of the tokens T that correspond to the various information of the meta information in the output token sequence is not particularly limited and can be appropriately determined in accordance with the embodiment.

At the machine learning stage, with respect to each of the training datasets 300, the learning processing module 112 uses the plurality of tokens T (input token sequences) that indicate the training music data 30 as training data (input data) and uses the plurality of tokens T (output token sequences) that indicate the corresponding arrangement data 35 as correct answer data (teacher signals) to execute the machine learning of the generative model 5. Specifically, the learning processing module 112 is configured to train the generative model 5 such that the output token sequence (inference result of the arrangement data), obtained by inputting the input token sequence that corresponds to the training music data 30 to the generative model 5 and carrying out the computation of the generative model 5, matches the corresponding correct answer data (known arrangement data 35) for each of the training datasets 300. In other words, the learning processing module 112 is configured to adjust the parameters of the generative model 5 such that the error between the arrangement data indicated by the output token sequence generated by the generative model 5 from the input token sequence that corresponds to the training music data 30, and the corresponding known arrangement data 35, becomes small, for each of the training datasets 300. A plurality of normalization methods (e.g., label smoothing, residual dropout, attention dropout) can be applied to the processing of the machine learning of the generative model 5.

At the inference stage (arrangement generation), starting from the beginning, the arrangement generation module 115 sequentially inputs the plurality of tokens T (input token sequence) that indicate the target musical piece data 20 of the arrangement to the encoder 50 (in the example of FIG. 6, the multi-head attention layer that is placed first after passing through the input embedding layer) of the trained generative model 5 and executes the computational processing of the encoder 50. As a result of this computational processing, the arrangement generation module 115 sequentially acquires the tokens T output from the trained generative model 5 (in the example of FIG. 6, the softmax layer placed last) to generate the arrangement data 25 (output token sequence). At the time of this processing, the arrangement data 25 can be generated using a search method such as beam search. More specifically, the arrangement generation module 115 can retain n candidate tokens in descending order of the score from the probability distribution of the values output from the generative model 5 and select the candidate tokens such that the total score of m consecutive tokens becomes highest, to generate the arrangement data 25 (n and m are integers greater than or equal to 2). This process can be applied to the processing for obtaining the inference result in the machine learning.

Other

Each of the software modules of the arrangement generation device 1 will be described in detail in the operation example described further below. In the present embodiment, an example in which each software module of the arrangement generation device 1 is realized by a general-purpose CPU is described. However, some or all of the software modules can be realized by one or more dedicated processors (e.g., application-specific integrated circuits (ASIC). Each of the modules described above can also be realized as a hardware module. Further, with respect to the software configuration of the arrangement generation device 1, the software modules can be omitted, replaced, or supplemented as deemed appropriate in accordance with the embodiment.

3. Operation Example

### 3.1 Process Procedure of Machine Learning

FIG. 9 is a flowchart showing one example of a processing procedure of machine learning of the generative model 5 carried out by the arrangement generation device 1 according to the present embodiment. The processing procedure related to machine learning described below is one example of a model generation method. However, the processing procedure of the model generation method described below is merely an example, and each step thereof can be changed as much as possible. With respect to the following process procedure, the steps can be omitted, replaced, or supplemented as deemed appropriate in accordance with the embodiment.

In Step S801, the electronic controller 11 operates as the training data acquisition module 111 and acquires the performance information 31 that constitutes each of the training datasets 300. In one example, the performance information 31 can be directly provided. In another example, the performance information 31 can be obtained from data in other formats, such as a musical score. As a specific example, the performance information 31 can be generated by analyzing the melody and the chords of known original data.

In Step S802, the electronic controller 11 operates as the training data acquisition module 111 and acquires the meta information 33 that corresponds to the performance information 31 of each case. The meta information 33 can be appropriately configured to indicate characteristics of the arranged musical piece. In the present embodiment, the meta information 33 can be configured to include at least one or more of difficulty level information, style information, composition information, or tempo information. The meta information 33 can be acquired by an input via the input device 14 from an operator who specified the performance information 31 (e.g., the person who input the original data). By the process of Steps S801 and Step S802, it is possible to acquire the training music data 30 of each of the training datasets 300.

In Step S803, the electronic controller 11 operates as the training data acquisition module 111 and acquires the known arrangement data 35 that correspond to the training music data 30 of each case. The known arrangement data 35 can be appropriately generated so that the data can be used as the correct answer data. That is, the known arrangement data 35 can be appropriately generated so as to indicate a musical piece obtained by arranging the musical piece indicated by the corresponding performance information 31 under the conditions indicated in the corresponding meta information 33. In one example, the known arrangement data 35 can be generated corresponding to the known original data used for the acquisition of the performance information 31. The meta information 33 can be acquired from the corresponding known arrangement data 35. The obtained known arrangement data 35 can be appropriately associated with the corresponding training music data 30. By the process of Step S801-Step S803, it is possible to obtain the plurality of training datasets 300.

In Step S804, the electronic controller 11 operates as the learning processing module 112 and converts the training data 30 (performance information 31 and the meta information 33) of each of the training datasets 300 into a plurality of tokens T. The electronic controller 11 thereby generates the input token sequence that corresponds to the training music data 30 of each of the training datasets 300. As described above, in the present embodiment, an input token sequence is configured such that after the tokens T that correspond to the meta information 33 are arranged, the tokens that correspond to the performance information 31 are arranged in chronological order.

As long as the processes of Step S801 and Step S802 are executed before Step S804, the order of the processes of Step S801-Step S804 is not limited to the example described above and can be suitably determined in accordance with the embodiment. In another example, the process of Step S802 can be executed before Step S801. Alternatively, the processes of Step S801 and Step S802 can be executed in parallel. In another example, the process of Step S804 can be executed in accordance with each of Step S801 and Step S802. That is, the electronic controller 11 can generate the tokens T of part of the performance information 31 in accordance with the acquisition of the performance information 31 and generate the tokens T of part of the meta information 33 in accordance with the acquisition of the meta information 33. In another example, the process of Step S804 can be executed before at least one of Step S801, Step S802, or Step S803. In another example, the processes of Step S803 and Step S804 can be executed in parallel.

Further, at least some of the processes of Step S801-Step S804 can be executed by another computer. In this case, the electronic controller 11 can acquire the computation result from another computer via a network, the storage medium 91, or another external storage device (such as NAS, an external storage medium, etc.) to achieve as least some of the processes of Step S801-Step S804. In one example, each of the training datasets 300 can be generated by another computer. In this case, the electronic controller 11 can acquire each of the training datasets 300 from another computer as the processing of Step S801-Step S803. At least some of the plurality of training datasets 300 can be generated by another computer, and the rest can be generated by the arrangement generation device 1.

In Step S805, the electronic controller 11 operates as the learning processing module 112 and executes the machine learning of the generative model 5 by using the plurality of training datasets 300 (training data 3). In the present embodiment, for each of the training datasets 300, the electronic controller 11 inputs, in order from the beginning, the tokens T included in the input token sequence obtained by the process of Step S804 to the generative model 5 and repeatedly executes the computation of the trained generative model 5, to sequentially generate the tokens T that constitute the output token sequence, as feed-forward computational processing. By this computation, the electronic controller 11 is able to acquire the arrangement data (output token sequence) that correspond to the training music data 30 of each case as the inference result. The electronic controller 11 then calculates the error between the obtained arrangement data and the corresponding known arrangement data 35 (correct answer data) and also calculates the gradient of the calculated error. The electronic controller 11 uses the error backpropagation method to backpropagate the gradient of the calculated error to calculate the error of the parameter value of the generative model 5. The electronic controller 11 adjusts the parameter value of the generative model 5 based on the calculated error. Until a prescribed condition (e.g., reaching a prescribed number of executions, or the sum of the calculated error becoming less than or equal to a threshold value) is met, the electronic controller 11 can repeat the adjustment of the parameter value of the generative model 5 by the series of processes described above.

By this machine learning, the generative model 5 is trained such that, for each of the training datasets 300, the arrangement data generated from the training music data 30 conform to the corresponding known arrangement data 35. Thus, as a result of the machine learning, it is possible to generate the trained generative model 5 that has learned the associative relationship between the output token sequence (known arrangement data 35) and the input token sequence (training music data 30) provided by each of the training datasets 300. In other words, it is possible to generate the trained generative model 5 that has acquired the ability to arrange the melody and the chords of the performance information 31 (original) to conform to the known arrangement data 35 (correct answer data) in accordance with the conditions indicated by the meta information 33.

In Step S806, the electronic controller 11 operates as the storage processing module 113 and generates information related to the trained generative model 5 generated by machine learning as the training result data 125. The training result data 125 holds information for reproducing the trained generative model 5. As one example, the training result data 125 can include information that indicates the value of each parameter of the generative model 5 obtained by the adjustment of the machine learning described above. In some cases, the training result data 125 can include information that indicates the structure of the generative model 5. For example, the structure can be specified by the number of layers, the type of layer, the number of nodes included in each layer, the connection relationship between nodes of adjacent layers, etc. The electronic controller 11 stores the generated training result data 125 in a prescribed storage area.

The prescribed storage area can be the RAM in electronic controller 11, the storage unit 12, the external storage device, a storage medium, or a combination thereof. The storage medium can be a CD, a DVD, or the like, and the electronic controller 11 can store the training result data 125 in the storage medium via the drive 16. The external storage device can be a data server, such as NAS. In this case, the electronic controller 11 can use the communication interface 13 to store the training result data 125 in the data server via a network. Further, the external storage device can be an external storage device connected to the arrangement generation device 1, for example.

Once the training result data 125 are stored, the electronic controller 11 ends the processing procedure of the machine learning of the generative model 5 according to the present operation example. The electronic controller 11 can repeat the processes of Steps S801-S806 periodically or at irregular intervals to update or generate new training result data 125. At the time of this repetition, at least part of the training data 3 used for the machine learning can be changed, modified, supplemented, deleted, etc., as deemed appropriate. The electronic controller 11 can thereby update or regenerate the trained generative model 5. If the storing of the result of the machine learning is not necessary, the process of Step S806 can be omitted.

### 3.2 Process Procedure of Arrangement Generation

FIG. 10 is a flowchart showing one example of a processing procedure related to the arrangement generation carried out by the arrangement generation device 1 according to the present embodiment. The processing procedure related to the arrangement generation described below is one example of the arrangement generation method. However, with respect to the processing procedure of the arrangement generation method described below, the steps can be omitted, replaced, or supplemented as deemed appropriate in accordance with the embodiment.

In Step S901, the electronic controller 11 operates as the target data acquisition module 114 and acquires the performance information 21 that indicates the melody and the chords of at least a part of the musical piece. In one example, the performance information 21 can be directly provided. In another example, the performance information 21 can be obtained from data in other formats, such as a musical score. As a specific example, the performance information 21 can be obtained by analyzing the original data as the object of arrangement.

In Step S902, the electronic controller 11 operates as the target data acquisition module 114 and acquires the meta information 23 that indicates characteristics of at least a part of the musical piece. In the present embodiment, the meta information 23 can be configured to include at least one or more of difficulty level information, style information, composition information, or tempo information. In one example, the meta information 23 can be automatically selected by the arrangement generation device 1 or another computer by a method such as determination in accordance with a prescribed rule, for example. In another example, the meta information 23 can be acquired by user input via the input device 14. In this case, the user can specify the desired arrangement condition. By the processes of Steps S901 and S902, the electronic controller 11 can acquire the target musical piece data 20 that include the performance information 21 and the meta information 23.

In Step S903, the electronic controller 11 operates as the arrangement generation module 115, and converts the performance information 21 and the meta information 23 included in the target musical piece data 20 to the plurality of tokens T. In this way, the electronic controller 11 generates the input token sequence that corresponds to the target musical piece data 20 of the arrangement. As described above, in the present embodiment, an input token sequence is configured such that after the tokens T that correspond to the meta information 23 are arranged, the tokens T that correspond to the performance information 21 are arranged in chronological order.

As long as the processes of Step S901 and Step S902 are executed before Step S903, the order of the processes of Step S901-Step S903 is not limited to the example described above and can be appropriately determined in accordance with the embodiment. In another example, the process of Step S902 can be executed before Step S901. Alternatively, the processes of Step S901 and Step S902 can be executed in parallel. In another example, the process of Step S903 can be executed in accordance with each of Step S901 and Step S902. That is, the electronic controller 11 can generate the tokens T of part of the performance information 21 in accordance with the acquisition of the performance information 21 and generate the tokens T of part of the meta information 23 in accordance with the acquisition of the meta information 23.

In Step S904, the electronic controller 11 operates as the arrangement generation module 115 and references the training result data 125 and carries out the setting of the trained generative model 5 by machine learning. If the setting of the trained generative model 5 is already completed, the process can be omitted. The electronic controller 11 generates the arrangement data 25 from the acquired target musical piece data 20 by using the trained generative model 5 trained by machine learning. In the present embodiment, the electronic controller 11 generates the output token sequence that corresponds to the arrangement data 25 by inputting the tokens T which are included in the generated input token sequence to the trained generative model 5 and executing the computation of the trained generative model 5. Further, in the present embodiment, the trained generative model 5 is configured to have a recursive structure. In the step for generating the output token sequence, the electronic controller 11 sequentially generates tokens that constitute the output token sequence by inputting the tokens T that are included in the input token sequence to the trained generative model 5 in order from the beginning and repeatedly executing the computation (feedforward computation described above) of the trained generative model 5.

As a result of this computation, it is possible to generate the arrangement data 25 that can be obtained by arranging the performance information 21 in accordance with the meta information 23. That is, even if the performance information 21 is the same, arrangement data 25 that are different can be generated by changing the meta information 23. In the case that the meta information 23 includes difficulty level information, in this Step S904, the electronic controller 11 can by using the trained generative model 5, generate the arrangement data 25 that correspond to the degree of difficulty indicated by the difficulty level information from the target musical piece data 20. In the case that the meta information 23 includes style information, in this Step S904, the electronic controller 11 can, by using the trained generative model 5, generate the arrangement data 25 that correspond to the style (arranger, artist) indicated by the style information from the target musical piece data 20. In the case that the meta information 23 includes composition information, in this Step S904, the electronic controller 11 can, by using the trained generative model 5, generate the arrangement data 25 that correspond to the musical instrument composition indicated by the composition information from the target musical piece data 20. In the case that the meta information 23 includes tempo information, in this Step S904, the electronic controller 11 can, by using the trained generative model 5, generate the arrangement data 25 that correspond to the tempo indicated by the tempo information from the target musical piece data 20.

In Step S905, the electronic controller 11 operates as the musical score generation module 116 and generates the musical score data 27 by using the generated arrangement data 25. In one example, the electronic controller 11 generates the musical score data 27 by using the arrangement data 25 and laying out elements such as notes and performance symbols.

In Step S906, the electronic controller 11 operates as the output module 117 and outputs the generated arrangement data 25. The output destination and the output format are not particularly limited and can be appropriately determined in accordance with the embodiment. In one example, the electronic controller 11 can output the arrangement data 25 as is to an output destination, such as the RAM, the storage unit 12, a storage medium, an external storage device, or another information processing device. In another example, outputting the arrangement data 25 can be performed by outputting the musical score data 27. In this case, the electronic controller 11 can output the musical score data 27 to an output destination, such as the RAM, the storage unit 12, a storage medium, an external storage device, or another information processing device. In addition to the foregoing, the electronic controller 11 can output a command to a printing device (not shown) to print the musical score data 27 on a medium such as paper. The printed musical score can be output in this way.

When the output of the arrangement data 25 is completed, the electronic controller 11 ends the process procedure of the arrangement generation according to the present operation example. The electronic controller 11 can repeatedly execute the processes of Steps S901-S906 periodically or at irregular intervals, in accordance with a user's request. At the time of this repetition, at least part of the performance information 21 and the meta information 23 that are input to the trained generative model 5 can be changed, modified, supplemented, deleted, etc., as deemed appropriate. In this way, the electronic controller 11 can use the trained generative model 5 to generate the arrangement data 25 that are different.

Features

As described above, in the present embodiment, in the process of Step S904, the arrangement data 25 is generated from the target musical piece data 20 that include the original performance information 21, by using the trained generative model 5 generated by machine learning. In Step S805, by using sufficient training data 3 to appropriately execute machine learning, the trained generative model 5 can acquire the ability to appropriately generate arrangement data from various original performance information. Thus, in Step S904, by using the trained generative model 5 that has acquired such an ability, the arrangement data 25 can be appropriately generated. In addition, by the meta information 23, it is possible to control the generation conditions of the arrangement data 25 so that various the arrangement data 25 can be generated from the same performance information 21. In addition, by using the trained generative model 5, it is possible to automate at least part of the process for generating the arrangement data 25. As a result, it is possible to reduce the man-hours required for manual work. Therefore, by the present embodiment, it is possible to reduce the cost of generating the arrangement data 25, as well as to suitably generate various the arrangement data 25.

In addition, in the present embodiment, by Step S905 described above, the musical score data 27 can be automatically generated from the generated arrangement data 25. In addition, by Step S906 described above, the musical score data 27 can be automatically output to various media (such as storage media and paper media). Thus, by the present embodiment, because the generation and the output of the musical score can be automated, it is possible to further reduce the man-hours required for manual work.

In addition, in the present embodiment, the meta information (23, 33) can be configured to include at least one or more of difficulty level information, style information, composition information, or tempo information. Consequently, in Step S904, it is possible to generate a variety of the arrangement data 25 that conform to at least one or more of the level of difficulty, style, musical instrument composition, or the tempo indicated by the meta information 23. Thus, by the present embodiment, it is possible to reduce the cost required to generate a plurality of variations (arrangement patterns) of the arrangement data 25 from the same performance information 21. Similarly, the performance information (21, 31) includes not only melody information but also harmony (chord) information. As a result, by the present embodiment, the chords in the generated arrangement data 25 can be controlled.

In addition, in the present embodiment, the music data (20, 30) are converted into an input token sequence, and the input token sequence is configured such that after the tokens T that correspond to the meta information (23, 33) are arranged, the tokens T that correspond to the performance information (21, 31) are arranged in chronological order. Additionally, the generative model 5 is configured to have a recursive structure; and each of the tokens T included in the input token sequence is input to the generative model 5 in order from the beginning. As a result, in the generative model 5, the computation result for the part before the target of the meta information (23, 33) and the performance information (21, 31) can be reflected in the computation for the part of the target of the performance information (21, 31). Thus, by the present embodiment, since the context of the meta information and the performance information can be suitably reflected in the inference process, the generative model 5 can generate suitable arrangement data. At the machine learning stage, the trained generative model 5 that has acquired the ability to generate such suitable arrangement data can be generated. At the arrangement generation stage, in Step S905, by using the trained generative model 5 that has acquired such an ability, the arrangement data 25 can be suitably generated.

4. Modification

An embodiment of this disclosure has been described above in detail, but the above-mentioned description is merely an example of this disclosure in all respects. It goes without saying that various refinements and modifications can be made without deviating from the scope of this disclosure. For example, the following alterations can be made. In the following, constituent elements that are the same as those in the embodiment described above have been assigned the same reference numerals, and descriptions of the features that are the same as those in the above-described embodiment have been appropriately omitted. The following modified examples can be combined as deemed appropriate.

4.1

In the example described above, the generative model 5 is configured to generate, from the melody and the chords included in the performance information, right-hand and left-hand piano parts as the arrangement data. However, arrangements are not limited to such an example. In the embodiment described above, the meta information (23, 33) can be configured to include composition information, and the musical instrument composition indicated by the composition information can be suitably generated (e.g., specified by the user) to generate arrangement data that include any part by the generative model 5. Examples of a musical instrument composition include a musical group composition that includes vocals, guitar, bass, drums, keyboard, and the like, a chorus composition that includes soprano, alto, tenor, bass, and the like, and a wind instrument composition that includes a plurality of woodwind instruments, a plurality of brass instruments, strings, bass, percussion instruments, and the like. By such a configuration, in Step S904 described above, it is possible to generate arrangement data 25 that have a plurality of different musical instrument composition parts, based on the same performance information 21. At the machine learning stage described above, it is possible to generate a trained generative model 5 that has acquired such an ability.

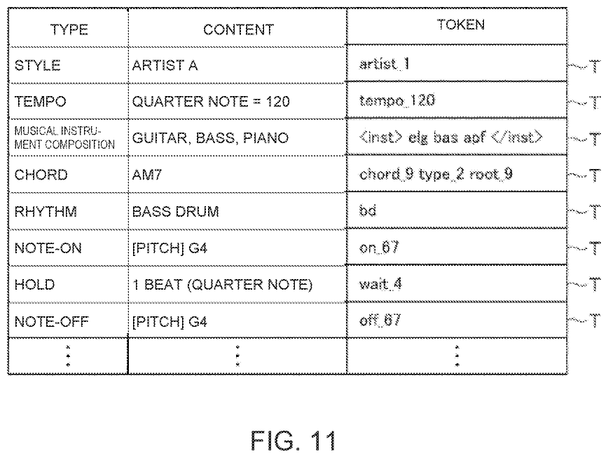

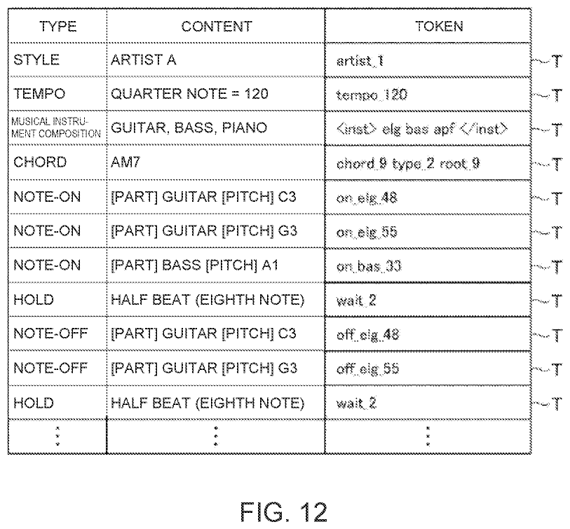

One example of the input format and the output format of the generative model 5 according to the present modified example will be described with reference to FIGS. 11 and 12. FIG. 11 is a diagram for explaining one example of an input format (token) of music data that are input to the generative model 5 according to the present modified example. FIG. 12 is a diagram for explaining one example of an output format (token) of the arrangement data that are output from the generative model 5 according to the present modified example.

As shown in FIG. 11, the input token sequence according to the present modified example includes musical instrument composition tokens (e.g., <inst> elg bas apf </inst>) together with the tokens T shown in FIG. 7 above. The musical instrument composition tokens include a plurality of musical instrument identification tokens (e.g., elg for guitar, has for bass, and apf for piano), each of which represents one musical instrument, a start tag token (<inst>) that indicates that a musical instrument composition token appears (the musical instrument composition token starts), and an end tag token (/inst) that indicates that the musical instrument composition token ends.

As shown in FIG. 12, the generative model 5 can thus identify the musical instrument composition by the musical instrument composition tokens and generate arrangement data (output token sequence) that correspond to the identified musical instrument composition. In the example of FIG. 12, the output token sequence output from the generative model 5 includes tokens T that indicate sounds (performance information) that respectively correspond to the plurality of musical instruments (e.g., guitar, bass, and piano) identified by the musical instrument composition tokens.

4.2

In addition, in the embodiment described above, the information included in the performance information (21, 31) is not limited to information that indicates the melody (melody) and chords (harmony) included in the musical piece. The performance information (21, 31) can include information other than the melody and the chords.

As one example, as shown in FIG. 11, the performance information (21, 31) can include beat information that indicates the rhythm of at least part of the musical piece, in addition to the information regarding the melody and the chords. In the example of FIG. 11, the input token sequence includes a beat token (e.g., the bd token of FIG. 11 that indicates a bass drum) that indicates the beat information. By the configuration described above, in Step S904, it is possible to generate the arrangement data 25 that more appropriately reflects the structure (rhythm) of the musical piece. At the machine learning stage described above, it is possible to generate a trained generative model 5 that has acquired such an ability.

4.3

In the Steps S901 and S902 according to the embodiment described above, the arrangement generation device 1 (electronic controller 11) can acquire a plurality of pieces of the target musical piece data 20 that respectively correspond to a plurality of parts obtained by dividing one musical piece (e.g., division into prescribed lengths, such as every four bars). In accordance with the foregoing, the electronic controller 11 can execute steps (Steps S903 and S904) for generating the arrangement data 25 with respect to each of the acquired plurality of pieces of target musical piece data 20 to generate a plurality of pieces of the arrangement data 25. The electronic controller 11 can then operate as the arrangement generation module 115 and integrate the generated plurality of pieces of arrangement data 25 to generate arrangement data that correspond to one musical piece. By this configuration, it is possible to reduce the number of computations of the generative model 5 that are executed at one time and to suppress the amount of data to be referenced by the attention layer. As a result, it is possible to generate arrangement data over the entire musical piece while reducing the computational load of the generation process.

4.4

In addition, in the embodiment described above, the arrangement generation device 1 is configured to execute operations for both the machine learning process and the arrangement generation (inference) process. However, the configuration of the arrangement generation device 1 is not limited to this example. In the case that the arrangement generation device 1 is composed of a plurality of computers, each step can be executed by at least one of the plurality of computer, so that the computation of each step is processed in distributed fashion. The computers can exchange data between each other via a network, a storage medium, an external storage device, etc. In one example, the machine learning process and the arrangement generation process can be executed by separate computers.

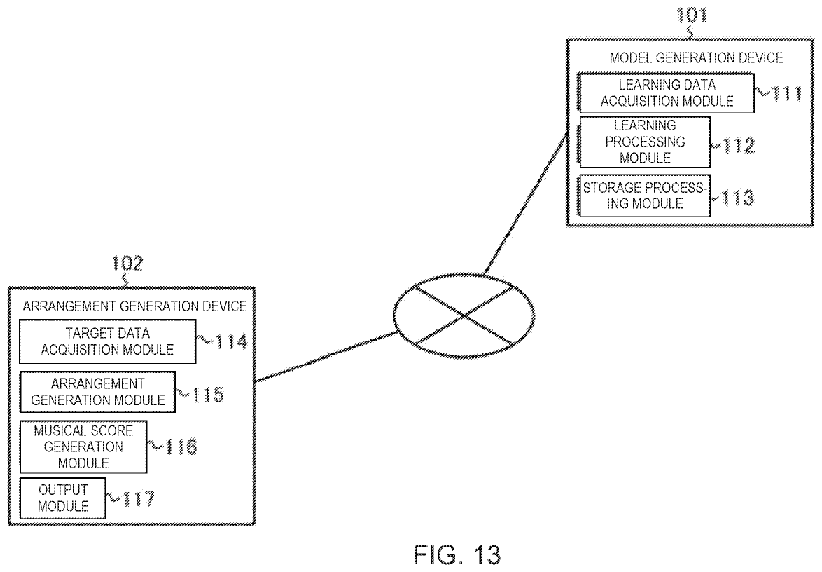

FIG. 13 schematically depicts another example of a scenario to which the invention is applied. A model generation device 101 is one or a plurality of computers configured to perform machine learning to generate the trained generative model 5. An arrangement generation device 102 is one or a plurality of computers configured to use the trained generative model 5 to generate the arrangement data 25 from the target musical piece data 20.

The hardware configuration of the model generation device 101 and the arrangement generation device 102 can be the same as that of the arrangement generation device 1 described above. As a specific example, the model generation device 101 can be a general-purpose server, and the arrangement generation device 102 can be a general-purpose PC, tablet PC, or a user terminal such as a smartphone. The model generation device 101 and the arrangement generation device 102 can be connected directly or via a network. In the case that the model generation device 101 and the arrangement generation device 102 are connected via a network, the type of network is not particularly limited and can be suitably selected from the Internet, a wireless communication network, a mobile communication network, a telephone network, a dedicated network, etc. However, the method of exchanging data between the model generation device 101 and the arrangement generation device 102 is not limited to this example and can be suitably selected in accordance with the embodiment. For example, data can be exchanged between the model generation device 101 and the arrangement generation device 102 through the use of a storage medium.

In the present modified example, the generation program 81 described above can be divided into a first program that includes commands for information processing related to the machine learning of the generative model 5 and a second program that includes commands for information processing related to the generation of the arrangement data 25 using the trained generative model 5. In this case, the first program can be referred to as a model generation program, and the second program can be referred to as an arrangement generation program. The arrangement generation program is one example of the generation program of this disclosure.

The model generation device 101 executes a part of the generation program 81 (the first program) related to the processing of machine learning to operate as a computer equipped with the training data acquisition module 111, the learning processing module 112, and the storage processing module 113 as software modules. The arrangement generation device 102, on the other hand, executes a part of the generation program 81 (the second program) related to the processing of arrangement generation to operate as a computer equipped with the target data acquisition module 114, the arrangement generation module 115, the musical score generation module 116, and the output module 117 as software modules.

In the present modified example, the model generation device 101 executes the processes of Steps S801-S806 described above to generate the trained generative model 5. The generated trained generative model 5 is generated. The generated trained generative model 5 can be provided to the arrangement generation device 102 as any timing. The generated trained generative model 5 (training result data 125) can be provided to the arrangement generation device 102 via a network, a storage medium, an external storage device, etc., for example. Alternatively, the generated trained generative model 5 (training result data 125) can be pre-installed into the arrangement generation device 102. The arrangement generation device 102, on the other hand, executes the processes of Steps S901-S906 described above to generate the arrangement data 25 from the target musical piece data 20 using the trained generative model 5.

4.5

in the embodiment described above, the generative model 5 has a recursive structure in accordance with the configuration of the Transformer shown in FIG. 6. However, the recursive structure is not limited to the example shown in FIG. 6. A recursive structure refers to a structure configured to reference input that occurred ahead of a target so as to be capable of executing the processing with respect to the input of the target (present). As long as such a computation is possible, the recursive structure is not particularly limited and can be suitably determined in accordance with the embodiment. In another example, the recursive structure can be configured in accordance with a known structure, such as RNN (Recurrent Neural Network), LSTM (Long short-term memory), etc.

In addition, in the embodiment described above, the generative model 5 is configured to have a recursive structure. However, the configuration of the generative model 5 is not limited to this example. The recursive structure can be omitted. The generative model 5 can be configured in accordance with a neural network having a known structure such as a fully connected neural network or a convolutional neural network. Further, the mode of inputting the input token sequence to the generative model 5 is not limited to the example of the embodiment described above. In another example, the generative model 5 can be configured to receive a plurality of tokens T contained in the input token sequence at one time.

In addition, in the embodiment described above, the generative model 5 is configured to receive input of the input token sequence that corresponds to the music data and to output the output token sequence that corresponds to the arrangement data. However, the input format and the output format in the generative model 5 are not limited to such an example. In another example, the generative model 5 can be configured to directly receive the music data. In addition, the generative model 5 can be configured to output the arrangement data directly.

Moreover, in the embodiment described above, as long as the arrangement data can be generated from the music data, the type of machine learning model that constitutes the generative model 5 is not particularly limited and can be suitably selected in accordance with the embodiment. Further, in the embodiment described above, in the case that the generative model 5 is composed of a plurality of layers, the type of each layer can be suitably selected in accordance with the embodiment. A convolution layer, a pooling layer, a dropout layer, a normalized layer, a fully connected layer, etc., can be used for each layer. The constituent elements of the structure of the generative model 5 can be omitted, replaced, or supplemented as appropriate.

4.6

In the embodiment described above, the generation of the musical score data 27 can be omitted. Therefore, in the software configuration of the arrangement generation device 1, the musical score generation module 116 can be omitted. In the process procedure related to the arrangement generation described above, the process of Step S905 can be omitted.

### Additional Statement

In order to solve the above-mentioned problem, this disclosure employs the following configuration. That is, in the arrangement generation method according to one aspect of this disclosure, a computer executes a step for acquiring target musical piece data that include performance information that indicates at least part of the melody and chords of a musical piece, and meta information that indicates characteristics of at least part of the musical piece, a step for using a generative model trained by machine learning to generate arrangement data from the acquired target musical piece data, where the arrangement data are obtained by arranging the performance information in accordance with the meta information, and a step for outputting the generated arrangement data.

In the above-described configuration, a trained generative model generated by, machine learning is used to generate arrangement data from target musical piece data that include the original performance information. By using sufficient training data for the suitable execution of machine learning, the trained generative model can acquire the ability appropriately to generate arrangement data from a variety of original performance information. Thus, by using a trained generative model that has acquired such an ability, the arrangement data can be suitably generated. In addition, with this configuration, meta information is included in the input of the generative model. By the meta information, it is possible to control the generation conditions of the arrangement data. Thus, by this configuration, a variety of arrangement data can be generated. Further, by this configuration, because the steps for generating the arrangement data can be automated, the cost for the generation of the arrangement data can be reduced. Thus, by the above-described configuration, it is possible to reduce the cost of generating arrangement data, as well as to provide a means for suitably generating various arrangement data.

By this disclosure, it is possible to provide a technology for reducing the cost of generating arrangement data, as well as to suitably generating a variety of arrangement data.

What is claimed is:

1. An arrangement generation method executed by a computer, the arrangement generation method comprises:
acquiring target musical piece data that include performance information that indicates a melody and a chord of at least a part of a musical piece, and include meta information that indicates characteristics of at least the part of the musical piece;
generating, from the target musical piece data, by using a generative model trained by machine learning, arrangement data obtained by arranging the performance information in accordance with the meta information; and
outputting the arrangement data.

2. The arrangement generation method according to claim 1, wherein
the meta information includes difficulty level information that indicates a degree of difficulty of playing the musical piece as a condition of arrangement, and
in the generating of the arrangement data, the arrangement data that correspond to the degree of difficulty indicated by the difficulty level information are generated from the target musical piece data by using the generative model.

3. The arrangement generation method according to claim 1, wherein
the meta information includes style information that indicates a musical style of the musical piece as a condition of arrangement, and
in the generating of the arrangement data, the arrangement data that correspond to the musical style indicated by the style information are generated from the target musical piece data by using the generative model.

4. The arrangement generation method according to claim 3, wherein
the style information includes arranger information for specifying an arranger.

5. The arrangement generation method according to claim 1, wherein
the meta information includes composition information that indicates a musical instrument composition of the musical piece as a condition of arrangement, and
in the generating of the arrangement data, the arrangement data that correspond to the musical instrument composition indicated by the composition information are generated from the target musical piece data by using the generative model.

6. The arrangement generation method according to claim 1, wherein
the performance information includes beat information that indicates a rhythm of at least the part of the musical piece.

7. The arrangement generation method according to claim 1, wherein
the generating of the arrangement data includes
generating an input token sequence that corresponds to the target musical piece data, and
generating an output token sequence that corresponds to the arrangement data by inputting a token included in the input token sequence to the generative model and executing computation of the generative model.

8. The arrangement generation method according to claim 7, wherein
the input token sequence is configured such that after a token that corresponds to the meta information is arranged, tokens that correspond to the performance information are arranged in chronological order,
the generative model is configured to have a recursive structure, and
in the generating of the output token sequence, tokens that constitute the output token sequence are sequentially generated by inputting tokens included in the input token sequence to the generative model in order from a beginning, and repeatedly executing the computation of the generative model.

9. The arrangement generation method according to claim 1, wherein
in the acquiring of the target musical piece data, a plurality of pieces of the target musical piece data each corresponding to each of a plurality of parts that are obtainable by dividing one musical piece are acquired, and
in the generating of the arrangement data, a plurality of pieces of the arrangement data are generated by performing the generating of the arrangement data with respect to each of the plurality of pieces of the target musical piece data, and the plurality of pieces of the arrangement data are integrated to generate the arrangement data that correspond to the musical piece.

10. The arrangement generation method according to claim 1, further comprising generating musical score data by using the arrangement data that have been generated.

11. An arrangement generation device comprising:
an electronic controller including at least one processor,
the electronic controller being configured to execute a plurality of modules including
a target data acquisition module configured to acquire target musical piece data that include performance information that indicates a melody and a chord of at least a part of a musical piece and include meta information that indicates characteristics of at least the part of the musical piece,
an arrangement generation module configured to generate, from the target musical piece data, by using a generative model trained by machine learning, arrangement data obtained by arranging the performance information in accordance with the meta information, and
an output module configured to output the arrangement data.

12. The arrangement generation device according to claim 11, wherein
the meta information includes difficulty level information that indicates a degree of difficulty of playing the musical piece as a condition of arrangement, and
the arrangement generation module is configured to generate the arrangement data that correspond to the degree of difficulty indicated by the difficulty level information from the target musical piece data by using the generative model.

13. The arrangement generation device according to claim 11, wherein
the meta information includes style information that indicates a musical style of the musical piece as a condition of arrangement, and
the arrangement generation module is configured to generate the arrangement data that correspond to the musical style indicated by the style information from the target musical piece data by using the generative model.

14. The arrangement generation device according to claim 13, wherein
the style information includes arranger information for specifying an arranger.

15. The arrangement generation device according to claim 11, wherein
the meta information includes composition information that indicates a musical instrument composition of the musical piece as a condition of arrangement, and
the arrangement generation module is configured to generate the arrangement data that correspond to the musical instrument composition indicated by the composition information from the target musical piece data by using the generative model.

16. The arrangement generation device according to claim 11, wherein
the performance information includes beat information that indicates a rhythm of at least the part of the musical piece.

17. The arrangement generation device according to claim 11, wherein
the arrangement generation module is configured to
generate an input token sequence that corresponds to the target musical piece data, and
generate an output token sequence that corresponds to the arrangement data by inputting a token included in the input token sequence to the generative model and executing computation of the generative model.

18. The arrangement generation device according to claim 17, wherein
the input token sequence is configured such that after a token that corresponds to the meta information is arranged, tokens that correspond to the performance information are arranged in chronological order,
the generative model is configured to have a recursive structure, and
the arrangement generation module is configured to sequentially generate tokens that constitute the output token sequence by inputting tokens included in the input token sequence to the generative model in order from a beginning and repeatedly executing the computation of the generative model, to generate the output token sequence.

19. The arrangement generation device according to claim 11, wherein
the electronic controller is further configured to execute a musical score generation module configured to generate musical score data by using the arrangement data that have been generated, and
outputting of the arrangement data is configured by outputting of the musical score data.

20. A non-transitory computer readable medium storing a generation program that causes a computer to execute a process, the process comprising:
acquiring target musical piece data that include performance information that indicates a melody and a chord of at least a part of a musical piece and include meta information that indicates characteristics of at least the part of the musical piece;
generating, from the target musical piece data, by using a generative model trained by machine learning, arrangement data obtained by arranging the performance information in accordance with the meta information; and
outputting the arrangement data.
